(19) United States
(12) Patent Application Publication
(10) Pub. No.: US 2007/0156005 A1
(43) Pub. Date: Jul. 5, 2007

(54) Method and system for examining and treating people with contagious diseases

(76) Inventor: Richard Paul Baum, Okemos, MI (US)

Correspondence Address: RICHARD P. BAUM, 470 CHIMNEY OAKS DRIVE, OKEMOS, MI, 48864, US

(21) Appl. No.: 11/593,336

(22) Filed: Nov. 6, 2006

Related U.S. Application Data
(60) Provisional application No. 60/734,129, filed on Nov. 7, 2005.

(51) Int. Cl. B09B 3/00; B09B 1/00; B09B 5/00

(52) U.S. Cl. 588/249

(57) ABSTRACT

A system by which a medical team of three people can safely operate, test and treat with medication, patients with possibly contagious diseases, whether the disease is a natural occurrence or a man made event, without wearing protective barrier suits. Whether the structures are mobile units or stationary buildings retro fitted to allow the CDC-TU method of treatment this system with all of the necessary applications and mechanical equipment will allow for the safe treatment of patients with contagious diseases to be tested and receive medication as quickly as possible.

### CROSS-REFERENCE TO RELATED APPLICATIONS

This application claims the benefit of U.S. Provisional Application No. 60/734,129 filed on Nov. 7, 2005.

### STATEMENT REGARDING FEDERALLY SPONSERED RESEARCH OR DEVELOPMENT

Not Applicable

### BACKGROUND OF THE INVENTION

### Field of the Invention

The present invention relates to a system that is designed to protect doctors and nurses and provide a means for the safe examination and treatment of people, at least initially, who are suspected of having a contagious disease. In particular, the present invention provides a method of treatment that includes some patient self testing in a negative air pressure situation. The attendant and doctors are in a positive air pressure situation and do not come into direct contact with the patient.

This system, the CDC-TU, has a point of care testing unit included as part of the facility. In this method of treatment the patient does some of the basic tests and is responsible for providing and sending the specimens to the POCT Lab. The Lab technician would then provide the doctor with results so that before he actually talks to the patient he already has the required medication that will give the patient the best chance for complete recovery. In most cases the patient will be given medication and be told to go home and be self isolated. If the test results show that the patient is in serious condition a medical staff member in a barrier suit will escort the patient to another unit that is set up for minimal care or more intensive care for extensive treatment. An option of isolation in a large isolation tent will always be an option in a pandemic situation.

### SUMMARY OF THE INVENTION

The present invention relates to a system and method for safely examining patients in a protected area while at the same time providing a much higher degree of protection to the medical staff operating the examination and treatment unit. The CDC-TU method will be a safer way to examine and treat twice as many patients and provide them with the medication that they need without visiting the Pharmacy on the way home. This method of treatment and the exam units can be stationary facilities that have been modified for the positive and negative pressure systems or the can be built as mobile units that can be moved to certain hard hit and heavily effected areas. The mobile units can be built as part of a complete Mobile Hospital These transportable units can be set up in other areas of the country or be flown to other countries where perhaps an earth quake or tsunami has destroyed their own hospital facilities.

The method is intended to protect as many people as possible from the effects dangerous pathogens, such as the bird flu, but the units can be used daily for other purposes. The units could be used as part of a training facility for new doctors and nurses or the same units could used as a way to reduce health care costs by offering a series of patient do-it-yourself health tests monitored by medical personal. The method would be set up in a mobile or stationary unit that would be divided into two sides. The doctors and nurses area would be pressurized with clean positive air (heated or cooled as needed). The patients area would be divided into several exam rooms that would provide some basic testing equipment. Some of the test that would be done by the patients themselves while under the supervision of the attendant or a nurse who has contact by way of wireless device or by a wall mounted inter come system. The wall separating the exam rooms from the doctor's corridor would have windows to allow the doctors to view the patient for more testing and conversation.

Some of the tests that can be done by the patients are weighing, temperature, pulse rate and heart rate, blood pressure and depending on the type of pathogen being tested for, there could be throat or saliva samples taken and sent to the POCT lab for testing.

Once the testing is complete and the doctor has had a short conversation with the patient the right course of action can be determined. If there is a natural influenza occurrence, such as bird flu pandemic, or if there is a terrorist attack using chemical agents it will be extremely important to quickly test and medicate as many people as possible without infecting the medical people providing the care.

The exact procedure to follow in the CDC-TU units would be for the patients to enter the CDC-TU facility, one at a time when the attendant indicates to them by cell phone or other means that it is OK to enter. They would then be instructed by the attendant at the desk to show identification and run Health Insurance card through card machine. The attendant would then print labels for the test that would be conducted in the POCT lab. The attendant would then instruct the patient to enter one of the exam rooms. The attendant would activate the assigned exam room motion sensor and when the patient arrives at the door it will automatically open to allow patient to enter the exam room. The patient enters the exam room and the door will close and latch after patient is safely inside. There will be no door knobs on the exam room doors.

Once inside, the patient will begin the various self testing procedure. The patient follows instructions on the monitor on the wall. The patient first pulls a package from a wall dispenser that has small tubs for throat and saliva specimens. The patient then collects the specimens and installs them into tubs and places labels on each tub and inserts the canister into the receptacle and sends it to the Lab, then continues with the remainder of the self examination. Once the POCT tests are completed and the information has been printed for the doctor and sent to his hand held device the doctor can obtain the necessary medication and visit the patient on the doctors' side of the exam room window. The doctor then has a short conversation with the patient and delivers the medication through one of the opening sleeves in the glass wall and closes the opening.

The patient then receives instructions from the doctor and gets the attendants OK to leave the facility through the exit door that will again open automatically. When the exam room door closes the attendant will turn off the exam room lights, lock the door and turn on the Ultra Violet lights to decontaminate the exam room before the next patient arrives.

Each of the CDC-TU facilities will require one attendant, one Poct Lab technician and one doctor.

The attendant will be in charge of the patients entering and leaving the facility along with directing the patient as to the procedure that they need to follow if they have questions about the self testing procedures. The POCT Lab technician will be responsible for receiving and running the lab tests in the confined area, one at a time as quickly as possible, inputting the information into the doctors hand held device and printing a hard copy of information and then properly disposing of the specimens in the on board incinerator which is at the end of the POCT lab area.

The doctor will be responsible for taking the lab test results data, the self testing information with him to see the patient. The doctor will then determine the proper course of action and the medication that would be required to give the patient the best chance for a quick recovery or determine whether the patient is clear to go home and be self isolated or be sent to one of the various other facilities for the appropriate treatment under more structured medical supervision.

One of the features that will make the CDC-TU method the best way to initially treat people who have been exposed to or may have been exposed to a dangerous pathogen or another person with a contagious disease is that the separation wall with a window can still allow the doctor to look into the eyes of the patient. The doctor can still, if absolutely necessary and with protective gloves, reach in and do a limited exam and even give the patient a shot if that is what is required. Once the shot has been administered the used syringe can be disposed of in the hazardous was receptacle on the wall In each of the exam room windows there would be two access openings with glove sleeves attached to allow some minimal protected contact with patient. The CDC-TU method will provide safe treatment for patients and allow the doctors, nurses and attendants the protection that they will need. This method will reduce the chances for the medical staff to be contaminated themselves and then to transfer the contagious disease to others. The method will at the same time allow them to treat many more people to be treated.

Not wearing a barrier suit will allow them to work more freely and not alarm the patients even though they are separated by glass window. The air filtration, heating and cooling and air pressure system is critical to the safety of the medical staff so, there will be generators with power back up systems available if the power goes off line. Water systems will have filters and a back up water filtration and storage system will be necessary on each unit. Each unit will have its own heating and cooling systems that will require LP Gas connection. One large LP gas storage tank will service the CDC-TU mobile units. The complete CDC-TU minimal care system includes one exam unit, one connecting corridor unit which has a emergency room for minor injuries and a minor care unit for over night stays when patient requires more than minimal care and has no one to help them at home. The CDC-TU maximum care facility has much more than the minimum care facility.

The Maximum care facility includes a unit that has emergency rooms that has ambulance drop off areas. There are additional units that support heart attack and stroke patients that also have a contagious disease.

All of these specialized units are connected to other mobile units to complete the first mobile hospital that is capable of treating people who have been exposed to or actually have a contagious disease. As part of a complete system for the treatment of patients with contagious diseases there needs to be a series of isolation structures that can be erected adjacent to the mobile treatment facility like the CDC-TU. The Z-Max 4040 is such a structure. It is an isolation unit that can be instrumental in handling hundreds of patients if the isolation units are erected in the right configuration.

The entire CDC-TU Hospital can be moved and set up very near the site of almost any disaster. Whether the cause is a natural disaster or a man made event such as a terrorist attack, the entire mobile hospital with the CDC-TU method of treatment built-in can be moved into the effected area and be up and operating in two to three days.

### BRIEF DESCRIPTION OF THE DRAWINGS

FIG. 1 is a floor layout of the exam unit of the present invention.

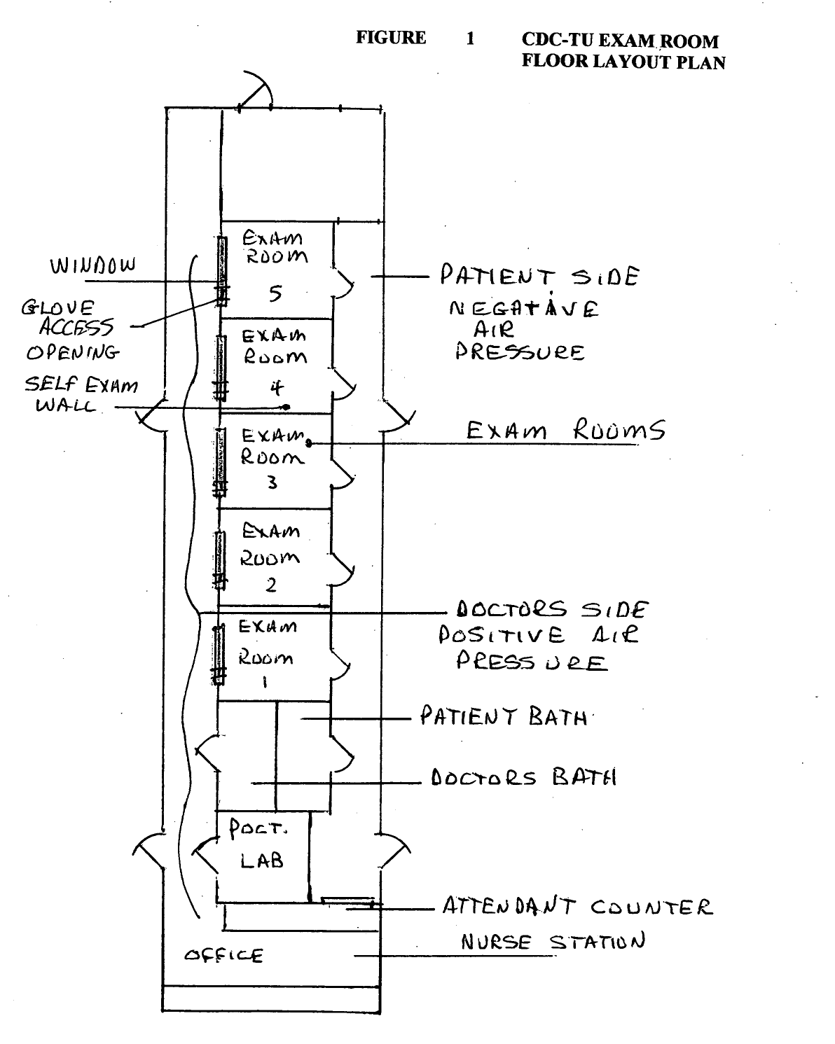

FIG. 2 is a floor layout of the connecting corridor unit with additional ER rooms for minor care.

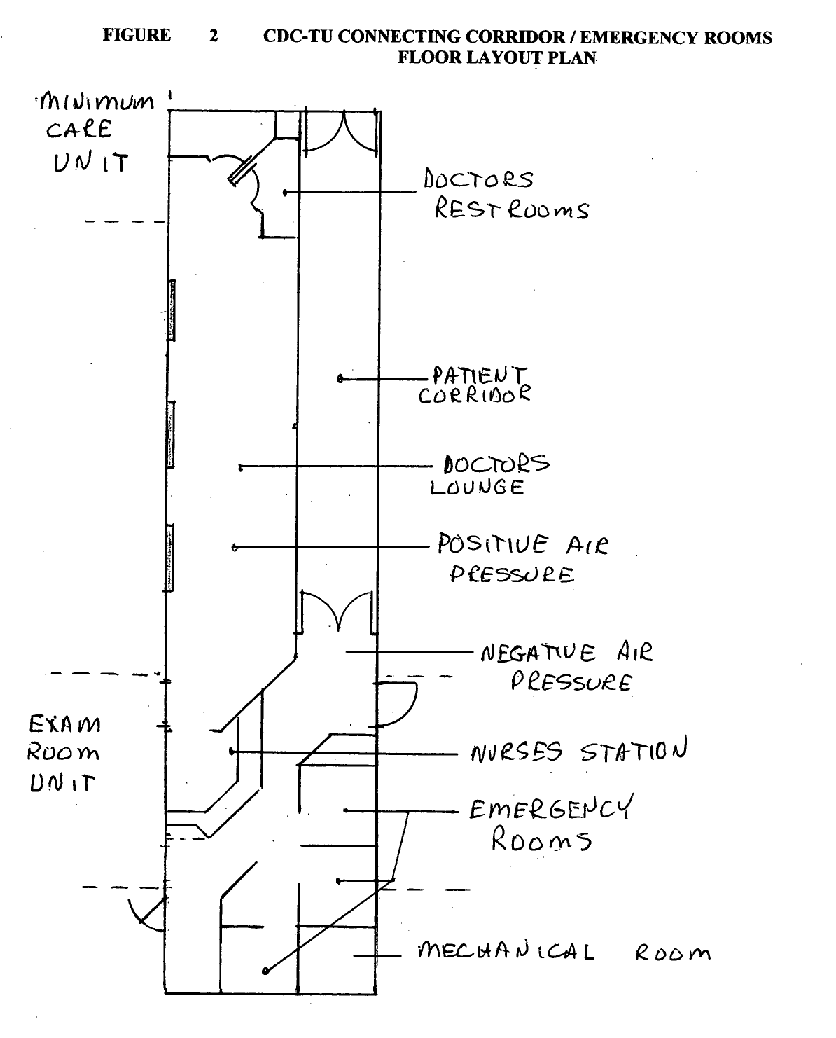

FIG. 3 is a floor layout of the minimum care unit for when the patient requires over night treatment and supervised care.

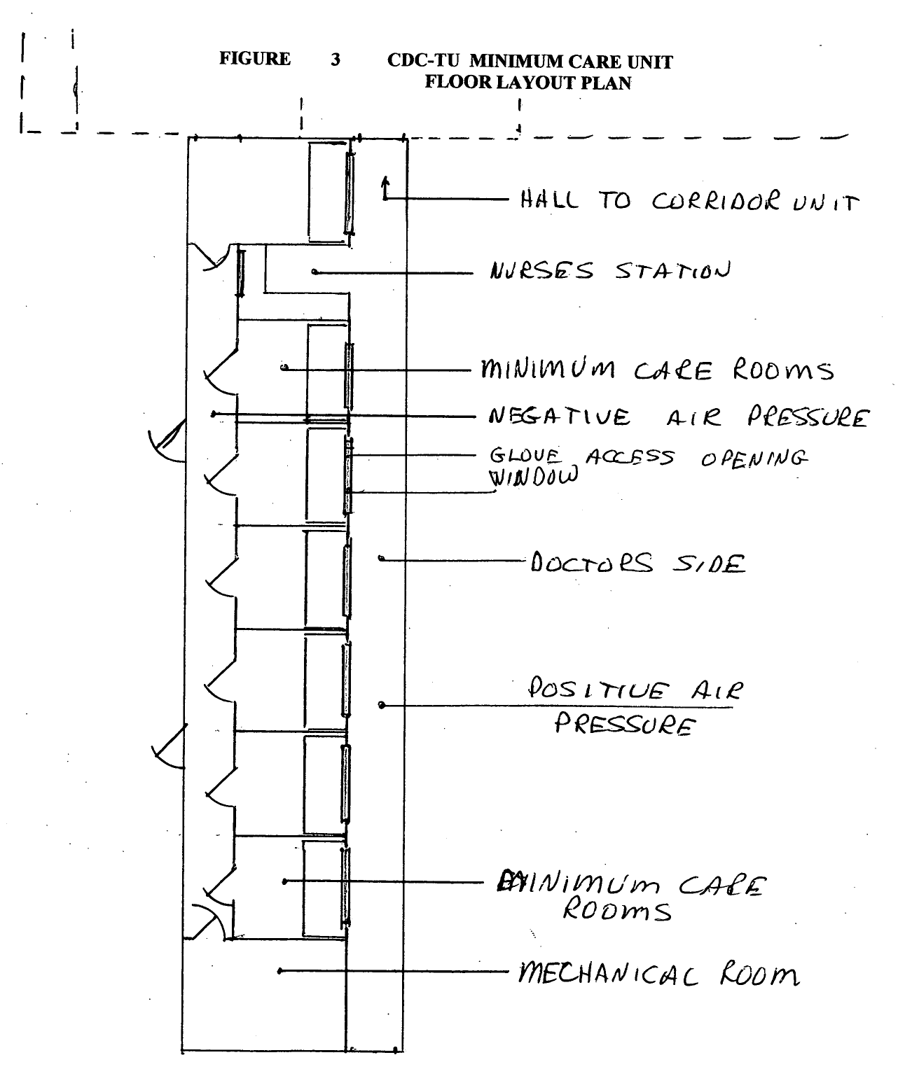

FIG. 4 is a flow chart showing a basic the steps of treatment and method present in this invention.

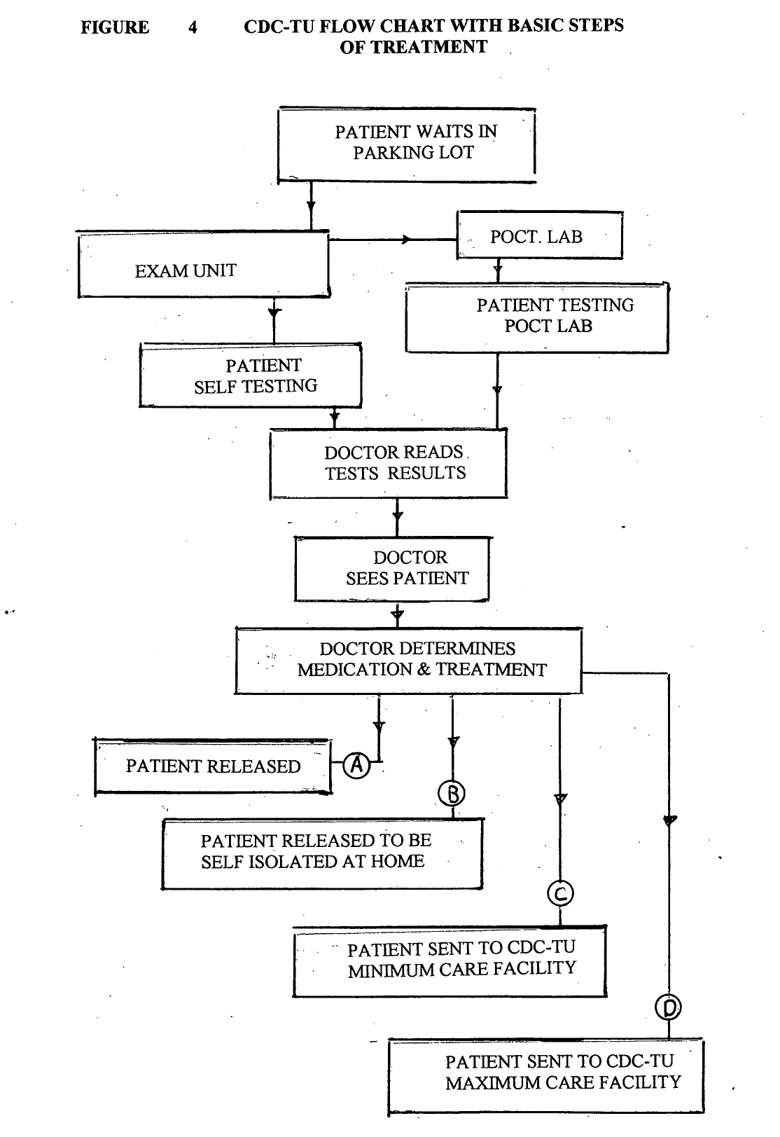

FIG. 5 is a more detailed flow chart showing the steps of treatment and method present in this invention.

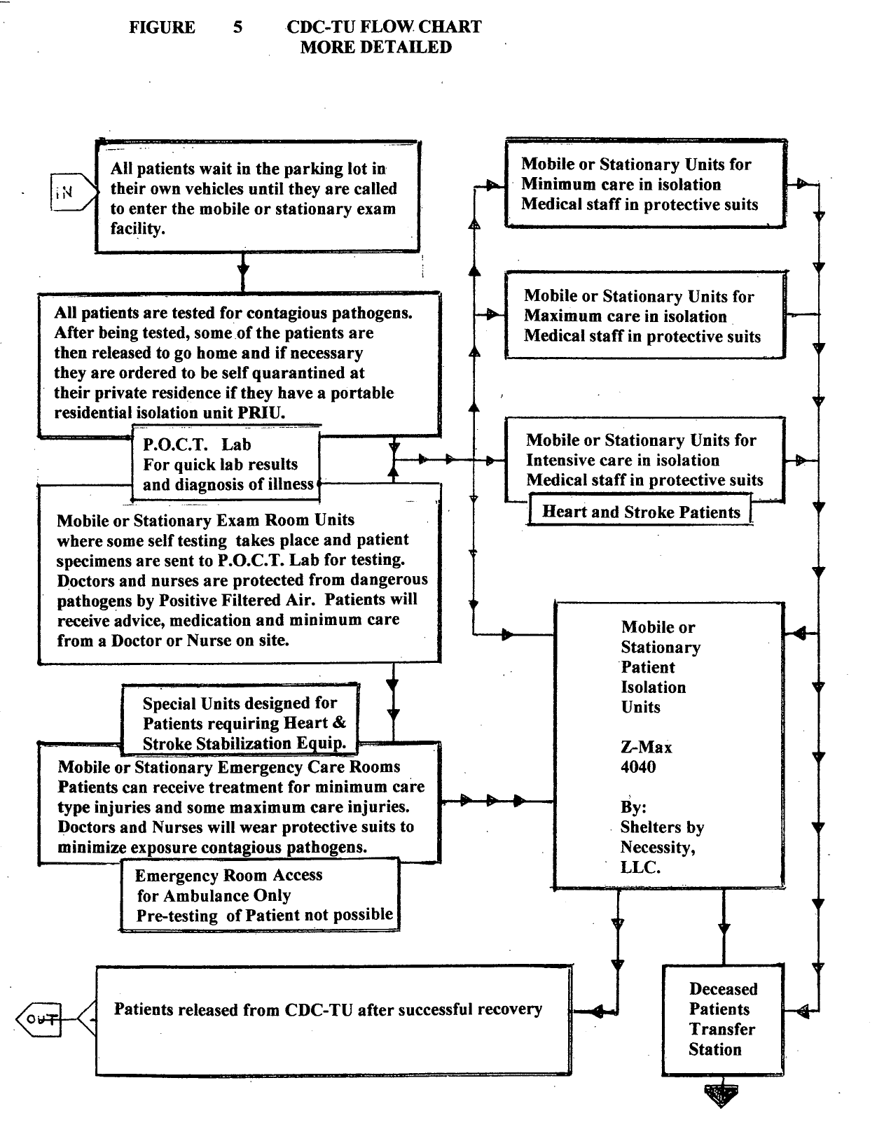

I claim:

1. A system that allows safe testing and treatment of patients possibly infected with a contagious diseases without requiring the doctors and nurses to wear protective barrier suits.
(a) a system or method that can be installed in a mobile unit that is built to be moved from place to place where ever it is necessary to aid in the treatment of people with contagious diseases, natural or man made in origin.
(b) a system or method that can be retro fitted into an existing building for the purpose of treating people with contagious diseases, natural or man made in origin.
(c) a system or method that can be installed in a newly constructed building for the purpose of treating people with contagious diseases, natural or man made in origin.
